(19) United States
(12) Patent Application Publication
(10) Pub. No.: US 2008/0057312 A1
(43) Pub. Date: Mar. 6, 2008

(54) Marking Articles

(76) Inventors: Harald Walter, Kilchberg (CH); Marc Schnieper, Onex-Geneve (CH); Alexander Stuck, Wettingen (CH)

Correspondence Address: FISH & RICHARDSON, PC, P.O. BOX 1022, MINNEAPOLIS, MN, 55440-1022, US

(21) Appl. No.: 11/575,063

(22) PCT Filed: Sep. 7, 2005
(86) PCT No.: PCT/IB05/02874

§ 371 Date: Mar. 9, 2007

(30) Foreign Application Priority Data
Sep. 9, 2004 (GB) 0419990.7

(51) Int. Cl. B32B 33/00; B29C 59/02

(52) U.S. Cl. 428/409; 264/109; 264/129; 264/293

(57) ABSTRACT

An article (1) such as a medicinal tablet or a foodstuff, has a microstructured surface (2). White light incident on the microstructure will be reflected at a number of different wavelengths dependent on the angle of incidence of the white light on the structure. This structure can provide an indication of authenticity of the article.

The invention relates to the marking of articles for authentication, identification or security.

Products or articles are currently protected against counterfeiting predominantly by attaching security labels to the products or to the packaging of the product. Such labels possess, for example, optical variable devices like holograms or colour changing inks, fluorescent dyes, special printing techniques like microprinting and the like. The main disadvantage of such labels is that they can be removed from the product or the packaging and reused or analysed.

Another approach is to mix highly characteristic isotopes, molecules or particles into the products. For example, short fragments of DNA can be used to mark products. U.S. Pat. No. 6,455,157 discloses a method for protecting and marking products by using microparticles which are attached or added to the product. Each microparticle has several colour layers forming a code. All these approaches modify the composition of the product which is very critical for pharmaceuticals or food. The modified products need new approvals, especially for pharmaceutical products. Such approvals have to be obtained from bodies such as the Federal Drugs Agency. A further disadvantage is that the marks are not visible and thus a reading device is necessary to enable their detection.

Another way of marking products is to locally destroy or modify their surface by intense radiation, for example using UV or IR lasers that can write data such as numbers, bar codes, and the like, in various substrates. However, the necessary equipment is expensive and the safety requirements for high intensity radiation sources are stringent and the written information can be easily copied. In addition, the speed of writing the data is low, especially compared with the production speed of pharmaceutical pills and tablets. Further the radiation can destroy the active agent or modify the flavour of the product.

The invention provides an article having a diffractive microstructure formed in or on a surface or an interface thereof to enable identification or authentication thereof.

Diffractive microstructures, particularly gratings, illuminated by polychromatic light show characteristic optical effects. The rainbow effect of holographic microstructures is well known and can be macroscopically structured to form logos, brand names, and the like. Such microstructures typically consist of gratings with periods from 500 nanometres up to a few micrometres. Microstructures with periods below 500 nm show special colour effects if they are combined with a high index of refraction layer. Such microstructures are generally called ‘zero order microstructures’.

The invention further provides a method of producing an article comprising forming a microstructure on or in the surface of the article or at an interface therein.

Applying such microstructures in the surface or an interface of products, for example by cold or hot embossing, overcomes the problem of removing and reusing the security feature. The structuring can only be destroyed. As the optical effects are based on interaction of light with structured interfaces between materials with different refractive indices they are applicable to many products. This is not obvious as most products are not transparent or reflective as is the case for substrates of state of the art holograms but absorbent or possess scattering surfaces. For example, black chocolate consists among other things of certain kinds of polysaccharides which are biopolymers with a refractive index of about 1.5 at 589 nm. Structuring the surface with a grating having a period between 0.75 μm and 3 μm produces a rainbow colour effect due to diffraction of light at the interface between air and chocolate. Although chocolate is normally dark coloured and may be black the absorption only modifies the colour effect without destroying it.

The method may comprise the additional step of coating the article at least in an area covering the microstructure with a transparent layer. This additional coating should be at least partially transparent in the visible spectral range and have an index of refraction at least slightly different from the structured material. In this case the microstructures are located at an interface of the product. The optical effects are modified but can still be seen. If the refractive index of the coating is higher than that of the structured material and the period between 200 and 600 nm a zero order colour effect can be obtained.

The above and other features and advantages of the invention will be apparent from the following description, by way of example, of embodiments of the invention with reference the accompanying drawings, in which:

FIG. 1 shows schematically the diffraction of white light at a microstructured surface of a pharmaceutical pill;

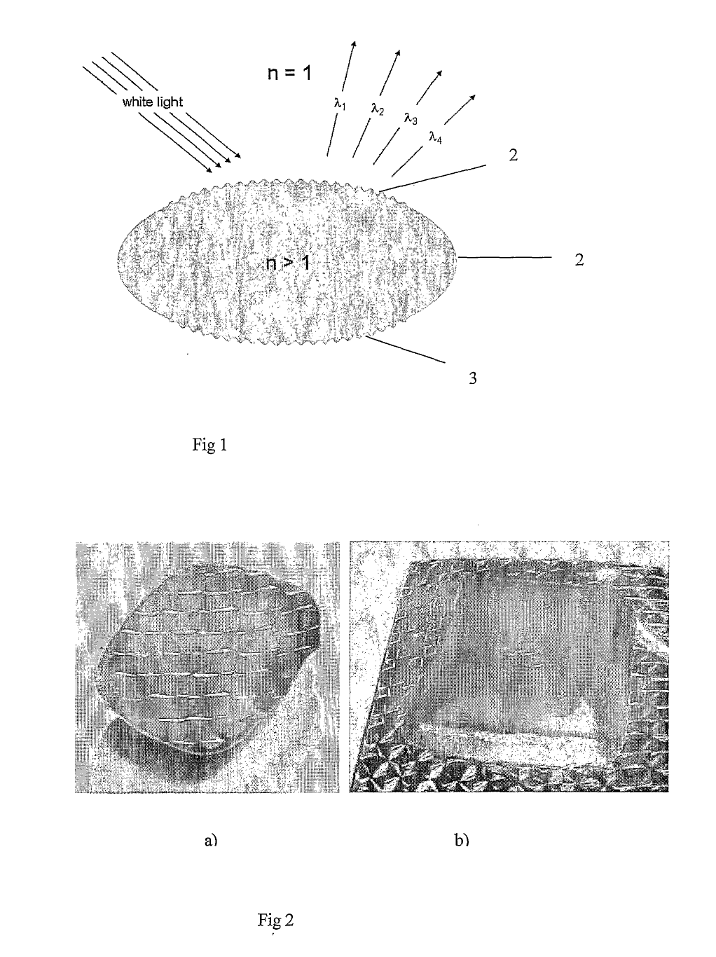

FIG. 2a is a photograph of a microstructured piece of chocolate;

FIG. 2b shows a piece of chocolate placed on a master during the implementation of the microstructure; and

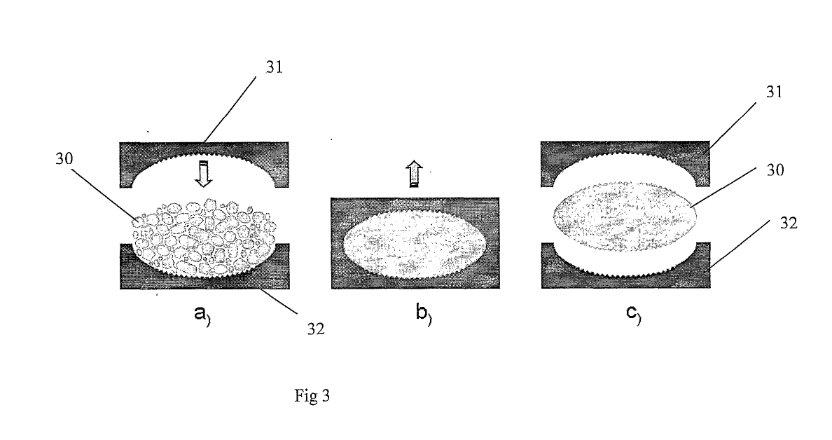

FIG. 3 depicts schematically a production method for adding microstructures to the surface of a pharmaceutical pill.

As shown in FIG. 1, a pill 1 has a microstructured surface 2 whose structure is shown on an enlarged scale for ease of illustration. In practice, typical periods are between 0.75 microns and 3 microns and the height is around 1 micron. The pills themselves will normally possess a diameter of greater than 3 mm. White light incident on the microstructure 2 will be reflected at a number of different wavelengths depending on the angle of incidence of the white light on the microstructure. A further microstructure 3 may be formed on an opposite surface of the pill. This microstructure may have the same properties as the microstructure 2 or may be dimensioned to have different properties.

The production of the microstructure can often be combined with the production of the product. In that case, the cost of adding them can be extremely low. For example, compacting presses may be used for compressing powdered materials into shaped tablets, preforms or briquettes. The structuring of the surface is done by a modified pressing tool which possesses the desired negative microstructure. Similarly, injection moulded products may be formed with the microstructure in place by means of an injection moulding tool which possesses the desired negative microstructure.

Further the microstructures can often only be implemented in a product at a certain step of the production line. For example such products may possess hard or sensitive surfaces at the end of the production process. For such products the invention offers a very high level of security.

FIG. 2a illustrates a block of chocolate the surface of which is microstructured and shows diffractive colour effects. FIG. 2b shows the piece of chocolate placed on a master during implementation of the microstructure. In this case the microstructuring is achieved by locally melting the surface of the chocolate to emboss the microstructures. The microstructures can be frozen into the surface by cooling the product. While this is illustrated with respect to chocolate it is applicable to any product that can be locally melted and then solidified once the microstructuring has taken place.

FIG. 3 illustrates a possible production method for adding microstructures to the surface of a pharmaceutical pill. First, a raw material in the form of a granular mixture is delivered within one half of a pressing tool 32. The upper half 31 is then lowered onto the lower half 32 compressing the granular mixture 30 between the two halves. This is shown in FIG. 3b. The two parts 31 and 32 of the pressing tool are then separated and the pill 30 is ejected. As can be seen from FIG. 3c the surface of the pill 30 is formed with the microstructure merely by use of the pressing tool

The invention is applicable to articles of many forms provided that they can be surface treated in some manner to form the microstructure. The invention is particularly useful in protecting articles that are likely to be the subject of counterfeit copies. Such articles might include, for example, spare parts for cars where the original manufacturer wishes to have some means of authenticating spare parts. In this way the customer can ensure that the part being supplied is from the manufacture and not from a counterfeiting source by means of the microstructure which is formed in the surface of the part. The microstructure may be applied during normal materials forming processes such as moulding, pressing, embossing, stamping, etc. Clearly in the case of spare parts the microstructure may be formed on a surface that is not visible once the spare part has been assembled into the product. Thus, for example, body panels for cars could have the microstructure formed on the inside of the panel to avoid any aesthetic problems with the external appearance of the car. A particular application could be in authenticating safety critical parts both for cars and for the aerospace industry.

1. An article having a diffractive microstructure formed in or on a surface or an interface thereof to enable identification or authentication thereof.

2. An article as in claim 1 in which the article or its surface is not completely transparent or metallic reflective but absorbent or scattering.

3. An article as in claim 1 comprising a grating having a period between 0.75 μm and 3 μm.

4. An article as in claim 1 in which the diffractive microstructure is a zero order microstructure.

5. An article as in claim 4 comprising a grating having a period between 0.2 μm and 0.6 μm.

6. An article as in claim 1 comprising a solid pharmaceutical product not in powder form.

7. An article as in claim 1 comprising a foodstuff.

8. An article as in claim 1 in which the diffractive microstructure is covered by a transparent layer of different refractive index from the microstructure.

9. An article as in claim 8 in which the refractive index of the transparent layer is higher than that of the microstructure.

10. A method of producing an article comprising forming a microstructure on or in the surface of the article or at an interface therein.

11. A method as in claim 10 comprising embossing the microstructure on the surface or at an interface of the article.

12. A method as in claim 10 comprising forming the article by means of a pressing or moulding operation, the microstructure being formed in the pressing or moulding process by forming the pressing or moulding tool with a negative version of the microstructure.

13. A method as in claim 10 in which the article is a solid pharmaceutical product formed by pressing a powder into a solid mass, the microstructure being formed on a surface of the solid mass during the pressing step by providing a negative master in the pressing tool.

14. A method as in claim 11 in which during the forming step at least the surface of the article is at least locally melted.

15. A method as in claim 10 comprising coating the article at least in an area covering the microstructure with a transparent layer having a different refractive index from the microstructure.

16. A method as in claim 15 in which the transparent layer has a higher refractive index than the microstructure.
